(19) United States
(12) Patent Application Publication
(10) Pub. No.: US 2026/0356102 A1
(43) Pub. Date: Nov. 12, 2026

(54) PRINTER WITH CURING UNIT

(71) Applicant: CANON KABUSHIKI KAISHA, Tokyo (JP)

(72) Inventors: Ton A.J.J. VAN BOMMEL, Nijmegen (NL); Fredericus P.H. THEUNISSEN, Oirlo (NL); Matheus Wijnstekers, Velden (NL)

(21) Appl. No.: 19/671,086

(22) Filed: May 7, 2026

(30) Foreign Application Priority Data
May 8, 2025 (EP) 25175174.9

(51) Int. Cl. B41J 11/00

(52) U.S. Cl. CPC B41J 11/00212; B41J 11/00214; B41J 11/00218

(57) ABSTRACT

A printer having a curing unit that is movable relative to a print medium on which an image has been printed, the curing unit comprising at least one radiation source for irradiating the print medium with curing radiation, and an optical system for concentrating the curing radiation onto a surface portion of the print medium, characterized in that the optical system is arranged to create, on the surface of the print medium, an intensity profile that is asymmetric in the direction of relative movement and comprises an intensity peak and an adjacent lower-intensity region.

### CROSS-REFERENCE TO RELATED APPLICATIONS

This application claims priority to European Patent Application No. 25175174.9 filed on May 8, 2025, which is incorporated by reference herein in its entirety.

### BACKGROUND

### Field of the Disclosure

The disclosure relates to a printer having a curing unit that is movable relative to a print medium on which an image has been printed, the curing unit comprising at least one radiation source for irradiating the print medium with curing radiation, and an optical system for directing the curing radiation onto a surface portion of the print medium.

### Description of the Related Art

US2022379633 A1 discloses an ink jet printer of this type wherein the curing unit comprises a plurality of radiation sources that are configured to irradiate the print medium with UV curing radiation at two different wavelengths. The radiation sources are arranged above the transport path of the print medium so as to irradiate a limited surface portion of the print medium with essentially uniform intensity. The intensity profile I(y), i.e. the intensity of the radiation at the surface of the print medium as a function of the position y in the direction perpendicular to the transport direction of the print medium, is symmetric, with a steep rise at a certain position y₀ and an equally steep decline at a position y₁ ˃ y₀, and the intensity is essentially constant in the interval between y₀ and y₁.

The curing radiation induces not only a curing reaction in the ink but also increases the temperature of the ink layer and the recording medium onto which the ink layer was applied. If the temperature of the recording medium reached a threshold value, then media deformation may occur. The threshold value may depend on the type of recording medium used. The possibility of media deformation puts an upper limit to the intensity of the curing radiation.

On the other hand, the radiation dose, i.e. the integral of the intensity profile I(x) over the distance x must be high enough to ensure complete curing of the ink and a sufficient robustness of the cured ink layer.

### SUMMARY

The present disclosure is directed to improving the robustness of the ink layer without causing media deformation.

According to the disclosure, in order to achieve this objective, the curing unit (16) comprising at least two radiation sources (28, 30, 32) for irradiating the print medium (10) with curing radiation, and an optical system (24, 26) for directing the curing radiation onto a surface portion of the print medium (10), wherein the optical system directs the radiation from a first radiation source (28) of the at least two radiation sources to create a first intensity profile (I₁) and directs the radiation from a second radiation source (30) of the at least two radiation sources to create a second intensity profile (I₂), the first intensity profile having a first maximum intensity and a first width in a direction of medium transport, the second intensity profile having a second maximum intensity and a second width in a direction of medium transport, wherein the first intensity is higher than the second intensity and the first width is smaller than the second width. Intensity may also be referred to as irradiance. Intensity profile may also be referred to as irradiance profile.

In an embodiment, the first intensity profile has a first maximum intensity in the range of 0.4 W/cm² – 6 W/cm². Preferably, the first intensity profile has a first maximum intensity in the range of 0.7 W/cm² – 4 W/cm², more preferably, the first intensity profile has a first maximum intensity in the range of 0.9 W/cm² – 2.5 W/cm². The first intensity profile may have a width, in a direction of medium transport, at the recording medium surface in the range of 2 mm – 20 mm, preferably in the range of 4 mm – 15 mm, more preferably in the range of 6 mm - 10 mm.

In an embodiment, the second intensity profile has a second maximum intensity in the range of 0.01 W/cm² – 0.5 W/cm². Preferably, the second intensity profile has a second maximum intensity in the range of 0.05 W/cm² – 0.4 W/cm², more preferably, the second intensity profile has a first maximum intensity in the range of 0.1 W/cm² – 0.25 W/cm². The second intensity profile may have a width, in a direction of medium transport, at the recording medium surface in the range of 10 mm – 150 mm, preferably in the range of 25 mm – 100 mm, more preferably in the range of 40 mm - 80 mm.

When the print medium is moved relative to the curing unit with a certain velocity v, which may be constant or not, the spatial intensity profile I(x) translates into an intensity time-profile I(t) = I(x(t)). When a given volume element of the ink layer reaches the region that is irradiated by the curing unit, it will first hit the peak of the intensity profile. However, since the peak is relatively narrow, the time during which the ink volume element traverses the peak may be so short that the radiation dose is not sufficient for fully curing the ink. Further curing may occur while the volume element traverses the lower-intensity region where the intensity is so low that the recording medium is not deformed due to excessive heating. As a result, the ink may be fully cured with a sufficient radiation dose. In this way, a fully cured and robust ink layer is obtained on a relatively short distance of travel of the print medium while avoiding media deformation.

More specific optional features of the disclosure are indicated in the dependent claims.

In an embodiment, the printer comprises at least three radiation sources configured to emit radiation of different types, wherein the optical system is configured to create different intensity profiles for the different types of radiation, each one of the intensity profiles having a maximum intensity and a width in the direction of medium transport.

In an embodiment, the curing radiation is directed such that the first maximum intensity is received on a first area of the recording medium, the second maximum intensity is received in a second area of the recording medium, the first area being positioned upstream in the direction of medium transport with respect to the second area.

In an embodiment, the at least two radiation sources are individually controllable. The plurality of radiation sources may be individually switched on or off. Optionally, the output level of the plurality of radiation sources may be controlled independently in a range of 0% to 100% of the output level. By controlling the plurality of radiation sources, the shape and intensity of the intensity profile may be controlled.

By individually controlling the at least two radiation sources, the dose and maximum intensity of radiation received by the medium may be controlled. For example, in case heat sensitive media are used, it may be advantageous to limit the maximum intensity of radiation received by the recording medium. Further, in case a multi-pass print strategy is used, it may also be beneficial to limit the maximum dose of radiation received by the recording medium. The dose of radiation is determined by the intensity of radiation and the duration of the radiation. In these cases, one of the at least two radiation sources may be switched off. For example, the first one of the at least two radiation sources may be switched off. In an alternative example, the second one of the at least two radiation sources may be switched off. In this way, the recording medium and the ink applied thereon may not receive a radiation dose exceeding a maximum dose of radiation.

In a further embodiment, the plurality of radiation sources may be individually controlled based on print job settings. Print job settings may include parameters such as type of medium used or print mode used. For example, if the recording medium is a heat sensitive medium, the plurality of radiation sources may be controlled such that the recording medium is not heated to a temperature exceeding a maximum allowable temperature. For example, if the print mode used is a print mode applying a plurality of layers, the plurality of radiation sources may be controlled such that an intensity profile having a high intensity is created to fully cure the plurality of layers.

In an embodiment, the at least one of the plurality of radiation sources comprises a plurality of individually controllable LEDs. The plurality of radiation sources may be page-wide arrays, comprising a plurality of individually controllable LED elements. The plurality of LED elements of a radiation source may be positioned adjacent to one another in a line extending in a scanning direction.

Optionally, each one of the plurality of radiation sources may be a page-wide array, each one of the page-wide arrays comprising a plurality of individually controllable LED elements.

The at least one of the plurality of radiation sources may be positioned downstream, in the sub-scanning direction with respect to the one or more print heads. Preferably, the optical system is positioned downstream, in the sub-scanning direction with respect to the at least one of the plurality of radiation sources. Preferably, the optical system is positioned upstream, in the sub-scanning direction with respect to the one or more print heads. The at least one of the plurality of radiation sources can emit radiation in a direction essentially perpendicular to the print medium.

In an embodiment, at least a first one of the radiation sources emits a type of radiation different from the type of radiation emitted by a second one of the radiation sources. The types of radiation may differ in at least one property of the radiation. Examples of properties of radiation include for example wavelength and intensity. Hence, at least a first one of the radiation sources emits a type of radiation having a different intensity and/or wavelength than the radiation emitted by a second one of the radiation sources.

The curing unit may comprise a plurality of radiation sources configured to emit different types of UV-radiation. At least two radiation sources of the plurality of radiation sources can emit a different type of UV radiation. The UV-radiation emitted by the respective radiation sources may differ in one or more properties, including wavelength and intensity. The radiation components with larger wavelengths may penetrate deeper into the ink layer and will therefore cause curing in the depth of the layer. The radiation component with the shortest wavelength will tend to penetrate less deep in the ink layer and may therefore mainly affect a fast curing of the surface layer of the ink.

The intensity profile may be selected differently for the different wavelengths. In particular, the profile having a peak and an adjacent lower-intensity region may be selected for the long-wavelength component, while the other wavelength components may have a more symmetric and flatter intensity profile.

The optical system may comprise a curved mirror, the curvature of which has an impact on the shape of the intensity profile. At least a part of the radiation emitted by the radiation source may be focused onto a point that is offset from the surface of the print medium. The intensity profile may then be caused to form a narrow peak by focusing the radiation onto a point that is close to the surface of the print medium.

If the curing unit comprises a plurality of radiation sources emitting radiation at different wavelengths, the intensity profile of the different wavelength components may be controlled by suitably positioning the radiation sources relative to the curved mirror. For example, the radiation sources may be arranged along a vertical line so as to emit the radiation towards the curved mirror in an essentially horizontal direction, and the curvature of the mirror may vary over the height, so that the radiation from the different radiation sources will be focused differently.

In order to obtain a distinctively asymmetric intensity profile, a part of the radiation that is focused by the curved mirror may be reflected at a secondary mirror so as to create a caustic at one end of the irradiated area.

In an embodiment, the curing unit moves relative to the print medium at a constant speed. If the printer has a page-wide printhead, the printhead and the curing unit may be stationary and the print medium may be moved at constant speed relative to the printhead and the curing unit. In a printer in which the printhead is moved in a main scanning direction so as to print successive swathes of the image, the print medium will be advanced step-wise. In that case, the curing unit may be moved back and forth in the sub-scanning direction such that the average velocity is zero and the velocity relative to the print medium is always constant.

In an embodiment, the printer comprises a print carriage, configured to move in reciprocation in a scanning direction during a printing operation. The scanning direction may be a direction perpendicular to a direction of media transport. The print carriage may comprise a plurality of print heads. The carriage may further carry one or more sources of radiation, preferably sources of UV radiation. The one or more sources of radiation may be provided at a lateral edge, in the scanning direction, of the print carriage. Preferably, the carriage carries two sources of radiation, each one of the sources of radiation being positioned at a lateral edge, in the scanning direction, of the print carriage.

### BRIEF DESCRIPTION OF THE DRAWINGS

Embodiment examples will now be described in conjunction with the drawings, wherein:

FIG. 1 is a side view of an ink jet printer according to an embodiment of the disclosure;

FIG. 2 is a diagram showing the relation between a transport speed of a print medium and a speed of a curing unit in the printer shown in FIG. 1;

FIG. 3 is the same side view as FIG. 1, but illustrating a radiation pattern for a different radiation source;

FIG. 4 shows intensity profiles of curing radiation.

FIG. 5 is a schematic perspective view of an example of a printing system according to the present disclosure in a first printing mode;

FIG. 6 is a schematic perspective view of an example of a printing system according to the present disclosure in a second printing mode;

FIG. 7 is a schematic diagram of a control unit of a reprographic system according to FIGS. 5 or 6;

### DESCRIPTION OF THE EMBODIMENTS

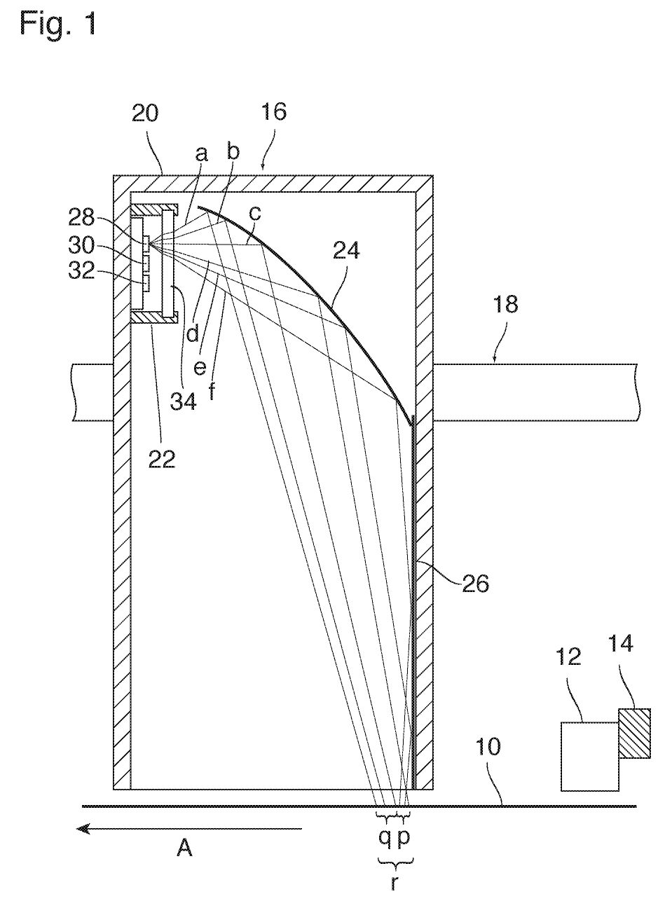

In the printer shown in FIG. 1, a print medium 10 is moved step-wise in a sub-scanning direction A past an ink jet print head 12 that prints an image onto the surface of the print medium 10 by applying a layer of a gelling-type ink onto the print medium. The sub-scanning direction A may also be referred to as a media transport direction, or direction of media transport. The printhead 12 is moved reciprocatingly along a gantry 14 in a main scanning direction that is normal to the plane of the drawing in FIG. 1. Thus, in each pass in the main scanning direction, the printhead 12 prints a swath of an image onto the print medium, whereafter the print medium 10 is advanced by the width of the swath, so that an adjacent swath can be printed in the next pass of the print head.

A curing unit 16 is arranged to be movable back and forth along guide rails 18 (only one of which has been shown) extending in a direction parallel to the sub-scanning direction A.

The curing unit 16 has a casing 20 that is open towards the transport path of the print medium 10 and accommodates a radiation source array 22, a curved primary mirror 24, and a flat secondary mirror 26. It will be understood that these components of the curing unit 16 extend over the entire width of the print medium 10.

In the example shown, the radiation source array 22 has three lines of radiation sources (LEDs) 28, 30, 32 that are vertically offset from one another and emit UV-radiation of different wavelengths in an essentially horizontal direction towards the primary mirror 24. For example, the topmost radiation sources 28 and the radiation sources 30 in the next lower line can emit radiation with a wavelength of 380-395nm, whereas the radiation sources 32 in the bottom line emit radiation with a longer wavelength of 400-410nm.

FIG. 1 illustrates the propagation of radiation that is emitted by the short-wavelength radiation sources 28. Each LED emits radiation ray a - f that traverse a transparent plate 34 and then propagate towards the primary mirror 24. Radiation ray a that is emitted slightly upwardly is deflected at the primary mirror 24 and hits the surface of the print medium 10 at a downstream end of an irradiated region r (downstream in the direction A of advance of the print medium). Radiation rays b to d are also deflected at the curved mirror 24 and hit the print medium 10 at positions progressively offset in the direction -A. Due to the curvature of the primary mirror 24, the radiation rays a and b are focused onto a focal point (not shown) that is somewhat below the plane of the print medium 10. However, since the curvature of the mirror 24 decreases towards the lower end, the focal point for radiation rays c and d that are emitted in a horizontal or even downward direction, the focal length is larger so that the points where these rays impinge on the print medium 10 are distributed over a larger region. Radiation rays e and f that are emitted downwardly at a larger angle are also deflected at the primary mirror 24 but do not hit the print medium 10 directly. Instead, they are reflected a second time at the flat secondary mirror 26 and hit the print medium 10 essentially at the same positions as the radiation rays c and d. Since the radiation rays that are deflected at the secondary mirror 26 are superposed with radiation rays that are only deflected at the primary mirror 24, a caustic i.e. a line-shaped region with high intensity is formed at the upstream end of the irradiated r area on the print medium 10. In an intensity profile taken in the sub-scanning direction A, these superposed radiation rays form an intensity peak p. At the downstream end of the irradiated area r (where the rays b and c impinge), the intensity of the radiation is lower because the rays deflected at the secondary mirror 26 do not reach this region. Here, the intensity profile has a low-intensity region q.

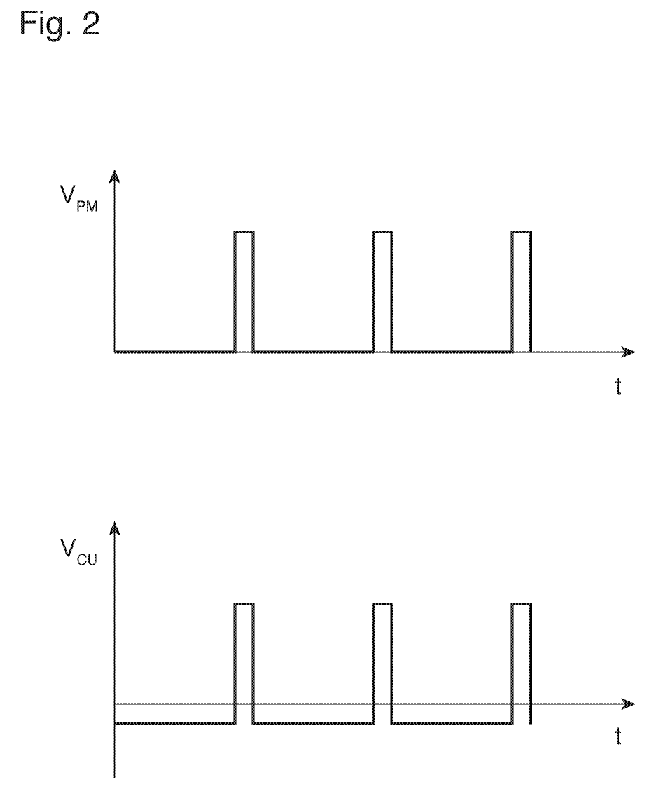

FIG. 2 shows the velocity V_{PM} of the print medium 10 relative to the gantry 14 and the velocity V_{CU} of the curing unit 16 relative to the gantry 14 as functions of the time t. While the print medium 10 is advanced step-wise, so that its velocity is 0 in the intervals between the steps, the curing unit 16 is slowly moved in the opposite direction (V_{CU} is negative) in the intervals between the steps. When the print medium is advanced during a step, the curing unit 16 is moved in the forward direction such that the difference V_{CU} - V_{PM} is negative and constant. In other words, the curing unit 16 is moved relative to the print medium 10 at a constant speed. Thus, when the curing unit 16 moves to the right in FIG. 1 (relative to the print medium 10), it reaches any point on the print medium 10 first with the peak p where the intensity is high, so that the ink will be cured quickly. Then, the low intensity region q will pass over that point, so that the ink will be cured further while, because of the low intensity, the temperature does not increase further.

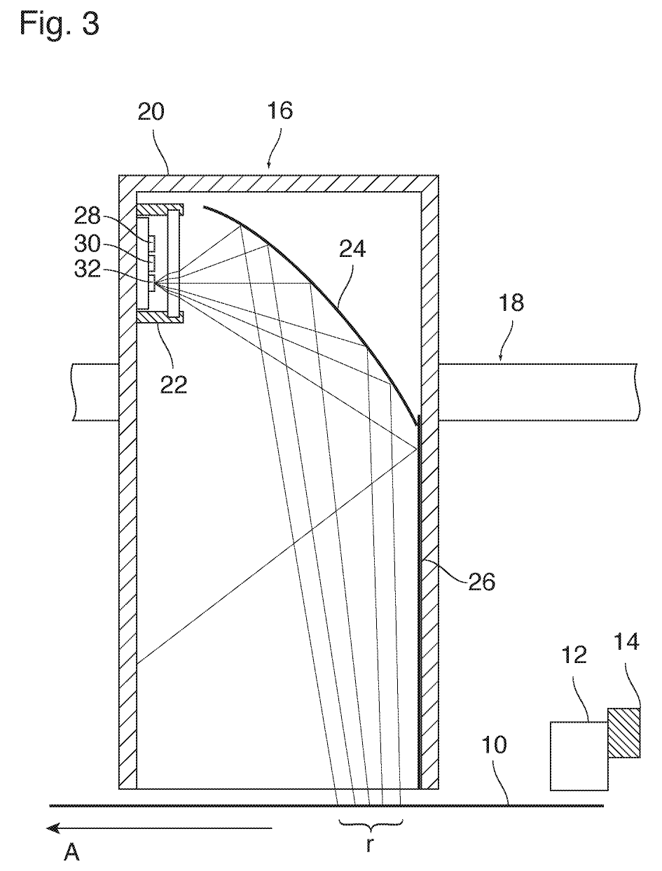

For comparison, FIG. 3 illustrates the propagation of radiation that is emitted by the radiation sources 32 in the bottom row. Because these radiation sources are in a lower position relative to the primary mirror 24, none of the radiation rays that are emitted by these radiation sources hit the primary mirror 24 at positions where the slope of the primary mirror is steeper, and none of them reaches the secondary mirror 26 so that no caustic is formed. Further, because of the lower curvature of the primary mirror 24 in its lower part, the focal length is larger, so that the radiation is distributed over a larger irradiated region r. Some radiation rays can hit the secondary mirror 26 directly, but will be deflected towards the wall of the casing 20.

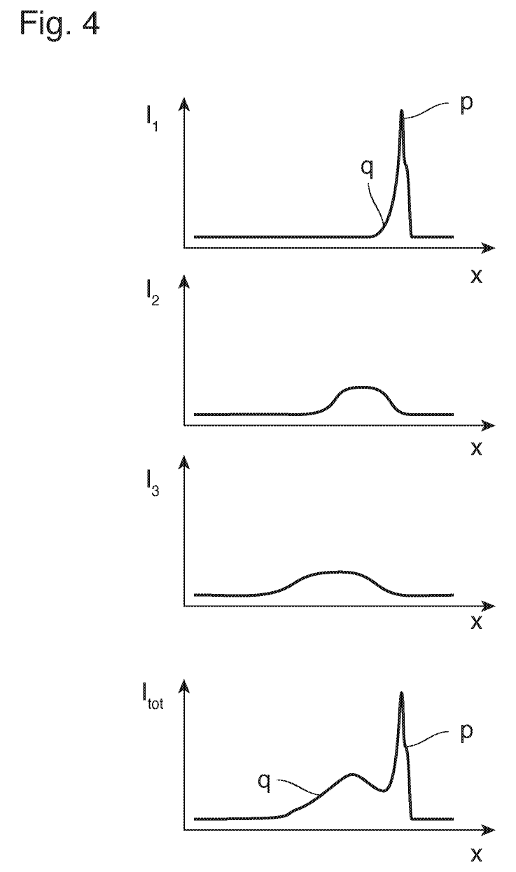

FIG. 4 shows intensity profiles I₁(x), I₂(x) and I₃(x) for the radiation that is emitted by the radiation sources 28, 30 and 32, respectively, as well as the total intensity profile Iₜₒₜ(x), which is the sum of the intensity profiles I₁(x) - I₃(x). Each intensity profile indicates the intensity with which the print medium is irradiated as a function of the position x in the sub-scanning direction A.

The radiation emitted by the radiation sources 28 and 30 have the same (short) wavelength but have different intensity profiles. The intensity profile I₁ features the peak p as well as the low-intensity region where the intensity is decaying. The intensity profile I₂ contributes only to the lower intensity region. In the example shown here, the radiation emitted by the radiation sources 30 does not hit the secondary mirror 26, so that the intensity profile I₂ is essentially symmetric. The intensity profile I₃ for radiation with a larger wavelength is also essentially symmetric and extends over a larger region. The superposition of all three intensity profiles I₁ - I₃ gives the total intensity profile Iₜₒₜthat is asymmetric and has the peak p and the lower intensity region q.

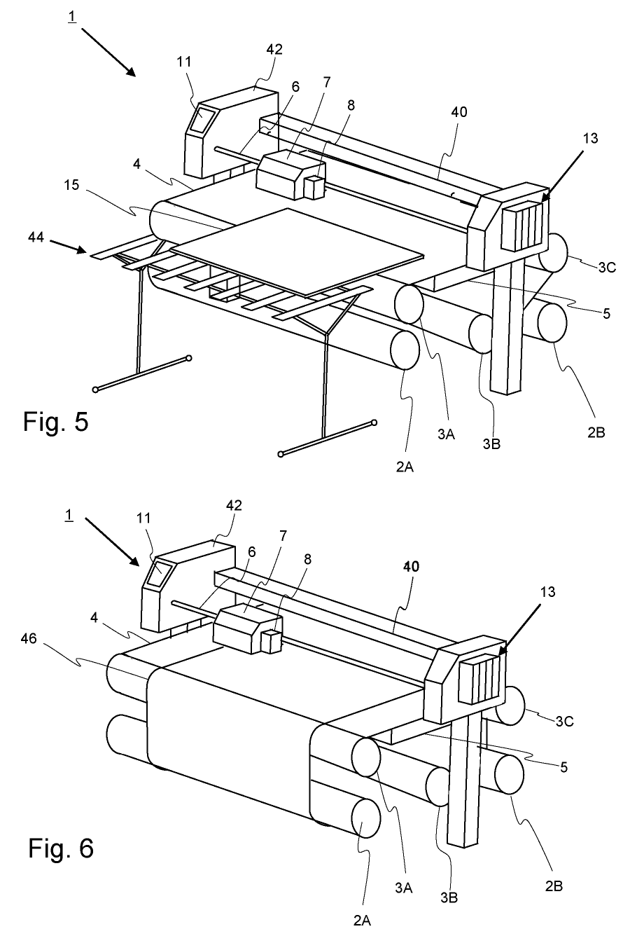

FIG. 5 shows a printing apparatus 1. A printing apparatus is also known as printer. The printing apparatus 1 comprises a scanning printing unit 7 for printing on a recording medium 15. The recording medium 15 in FIG. 5 is a relatively rigid substrate, such as a panel. The recording medium 15 is supplied from a media input unit 44, which may be configured for storing a plurality of such print media 15 and supplying these to the printer 1. The printer 1 comprises a medium support 4. Printer 1 may further comprise transport means for receiving and transporting the recording medium 15 along the scanning printing unit 7. In FIG. 5, the medium support is embodied as an endless belt 4. The endless belt is an endless transport belt 4 supported on a plurality of support rollers 3A, 3B, 3C. At least one of the support rollers 3A, 3B, 3C is provided with driving means for moving the belt 4. The belt 4 is therefore configured to support and transport the recording medium 15. Additionally, one or more of the support rollers 3A, 3B, 3C can be configured to be moved and/or tilted to adjust and control the lateral position of the belt 4. The scanning printing unit 7 may be provided with a sensor 8, such as a CCD camera, to determine the relative position of belt 4 and/or the recording medium 15. Data from said sensor 8 may be applied to control the position of the belt 4 and/or the recording medium 15. The belt 4 is further provided with through-holes and a suction box 5 in connection with a suction source (not shown), such that an underpressure may be applied to the recording medium 15 via the through-holes in the belt 4. The underpressure adheres the recording medium 15 flatly to the belt 4 and prevents displacement of the recording medium 15 with respect to the belt 4. Due to this holding, the belt 4 is able to transport the recording medium 15. It will be appreciated that other suitable transport means, such as rollers, steppers, etc, may alternatively be applied. The recording medium 15 may be transported stepwise and/or in continuous movement.

The scanning printing unit 7 is configured to translate along a first guide beam 6 in a scanning direction. The scanning direction is perpendicular to the direction in which the print medium is transported by the belt 4. The scanning printing unit 7 holds a plurality of print heads (not shown), which are configured to jet a plurality of different marking materials (different colors of ink, primers, coatings, etc.) on the recording medium 15. Each marking material for use in the scanning printing unit 7 is stored in one of a plurality of containers arranged in fluid connection with the respective print heads for supplying marking material to said print heads to print an image on the recording medium 15.

The application of the marking material, such as the radiation-curable ink from the printing units is performed in accordance with data provided in the respective print job. The printing unit 7 may comprise one or more inkjet print heads. The timing by which the droplets of marking material are released from the one or more print heads determines their position on the recording medium 15. The timing may be adjusted based on the position of the scanning printing unit 7 along the first guide beam 6. The above mentioned sensor 8 may therein be applied to determine the relative position and/or velocity of the scanning printing unit 7 with respect to the recording medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the recording medium 15. Therefore, it may be advantageous to remove excess marking material from the nozzle surface. The excess marking material may be removed for example by wiping with a wiper and/or by application of a suitable anti-wetting property of the surface, e.g. provided by a coating.

The marking materials may require treatment to properly fixate them on the print medium. Thereto, a curing unit is provided downstream of the scanning printing unit 7. A curing unit is also known as a fixation unit. The fixation unit may emit radiation to facilitate the marking material fixation process. In the example of FIG. 5, the fixation unit is a page-wide curing array 40. The page-wide curing array 40 extends in the main scanning direction. The page-wide curing array 40 does not move in operation in the main scanning direction. The page-wide array 40 can move in the direction of medium transport, which is a direction perpendicular to the scanning direction.

The page-wide curing array 40 is configured to, in operation, emit radiation of certain frequencies, which interacts with the marking materials, for example UV light in case of UV-curable inks. Optionally (not shown), the scanning printing unit 7 may be provided with a further fixation unit on the same carriage that holds the print heads. This further fixation unit can be used to (partially) cure and/or harden the marking materials, independent of or interaction with the page-wide curing array 10.

The page-wide curing array 40 is further provided with an optical system for directing the curing radiation onto a surface portion of the print medium 15 (not shown).

After printing and fixation, the recording medium 15 is transported to a receiving unit (not shown). The receiving unit may comprise a take-up roller for winding up the recording medium 15, a receiving tray for supporting sheets of recording medium 15, or a rigid media handler, similar to the media input unit 44. Optionally, the receiving unit may comprise processing means for processing the medium 15 after printing, e.g. a post-treatment device such as a coater, a folder, a cutter, or a puncher.

The printing apparatus 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 42 connected to the printer 1. The control unit 42, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 42 of the printer 1 may be provided with an input port, such as a USB port, so printing jobs may be sent to the printer 1 via this input port.

### Hybrid printing system

The printer 1 in FIG. 5 is a so-called hybrid printer, capable of handling both flexible media and rigid substrates. In FIG. 5, the printer 1 operates in a first print mode, wherein the printer 1 is configured for transporting rigid substrates, such as the recording medium 15. Such rigid print media 15 may be panels, for example panels for doors or walls, corrugated media, plates formed of plastic or metal, etc. To handle these rigid print media 15, the printer 1 in FIG. 5 is configured with a substantially linear transport path: from the media input device 44, the recording medium 15 moves forward along the scanning printing unit 7 at a substantially constant height. The media input unit 44 and the receiving unit are positioned at the level of the medium support surface of the belt 4. In FIG. 6, a flexible web medium 46 is supplied to the printer 1, which web medium 46 may be composed of e.g. paper, label stock, coated paper, plastic or textile. The web medium 46 is supplied from the input roller 2A and extends across the belt 4 to the take-up roller 2B, where the web medium 46 is re-wound. The printer 1 is configured to swiftly and efficiently switch between print modes.

### Control

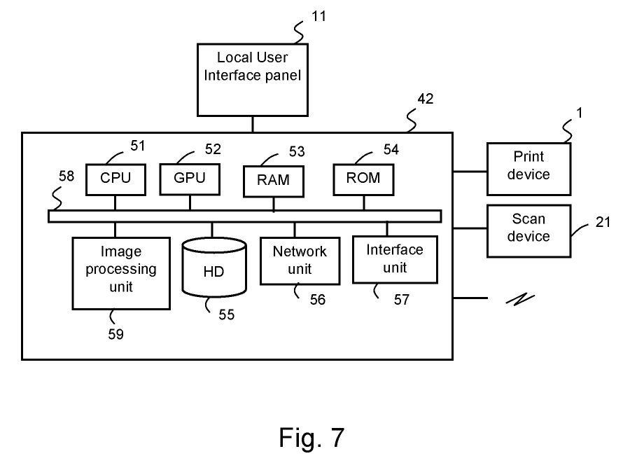

An embodiment of the control unit 42 is in more detail presented in FIG. 7. As shown in FIG. 7, the control unit 42 comprises a Central Processing Unit (CPU) 51, a Graphical Processor Unit (GPU) 52, a Random Access Memory (RAM) 53, a Read Only Memory (ROM) 54, a network unit 56, an interface unit 57, a hard disk (HD) 55, and an image processing unit 59 such as a Raster Image Processor (RIP). The aforementioned units 51 - 57 are interconnected through a bus system 58. However, the control unit 42 may also be a distributed control unit.

The CPU 51 controls the printing device/system 1 in accordance with control programs stored in the ROM 54 or on the HD 55 and the local user interface panel 5. The CPU 51 also controls the image processing unit 59 and the GPU 52. The ROM 54 stores programs and data such as boot program, set-up program, various set-up data or the like, which are to be read out and executed by the CPU 51. The hard disk 55 is an example of a non-volatile storage unit for storing and saving programs and data that make the CPU 51 execute a print process to be described later. The hard disk 55 also comprises an area for saving the data of externally submitted print jobs. The programs and data on the HD 55 are read out onto the RAM 53 by the CPU 51 as needed. The RAM 53 has an area for temporarily storing the programs and data read out from the ROM 54 and HD 55 by the CPU 51, and a work area which is used by the CPU 51 to execute various processes. The interface unit 57 connects the control unit 42 to the client devices, such as a scan device 21 and to the printing device/system 1. The network unit 56 connects the control unit 42 to the network N and is designed to provide communication with the workstations (not shown) and with other devices 21 reachable via the network N. The image processing unit 59 may be implemented as a software component running on an operating system of the control unit 42 or as a firmware program, for example embodied in a field-programmable gate array (FPGA) or an application-specific integrated circuit (ASIC). The image processing unit 59 has functions for reading, interpreting and rasterizing the print job data. Said print job data contains image data to be printed (i.e. fonts and graphics that describe the content of the document to be printed, described in a Page Description Language or the like), image processing attributes and print settings.

1. A printer comprising:
a curing unit that is movable relative to a print medium in a direction of medium transport, the curing unit comprising:
at least two radiation sources configured to irradiate the print medium with curing radiation; and
an optical system configured to direct the curing radiation onto a surface portion of the print medium,
wherein the optical system directs the radiation from a first radiation source of the at least two radiation sources to create a first intensity profile and directs the radiation from a second radiation source of the at least two radiation sources to create a second intensity profile,
wherein the first intensity profile having a first maximum intensity and a first width in the direction of medium transport, the second intensity profile having a second maximum intensity and a second width in the direction of medium transport, and
wherein the first intensity is higher than the second intensity and the first width is smaller than the second width.

2. The printer according to claim 1, further comprising at least three radiation sources configured to emit radiation of different types, wherein the optical system is configured to create different intensity profiles for the different types of radiation, each one of the intensity profiles having a maximum intensity and a width in the direction of medium transport.

3. The printer according to claim 1, wherein the optical system directs the curing radiation such that the first maximum intensity is received on a first area of the print medium, the second maximum intensity is received in a second area of the print medium, the first area being positioned upstream in the direction of medium transport with respect to the second area.

4. The printer according to claim 1, wherein the at least two radiation sources are individually controllable.

5. The printer according to claim 4, wherein at least one of the plurality of radiation sources comprises a plurality of individually controllable LEDs.

6. The printer according to claim 1, wherein at least the first radiation source emits a type of radiation different from the type of radiation emitting by the second radiation source.

7. The printer according to claim 6, wherein at least two of the at least two radiation sources are UV-radiation sources emitting radiation with different wavelengths.

8. The printer according to claim 7, wherein the optical system is configured to generate a symmetric intensity profile for at least one wavelength component.

9. The printer according to claim 7, wherein the wavelength component with the shortest wavelength has an asymmetric intensity profile.

10. The printer according to claim 7, wherein an overall intensity profile, the overall intensity profile being the sum of all intensity profiles, is asymmetric in the medium transport direction.

11. The printer according to claim 1, wherein the optical system comprises a curved mirror.

12. The printer according to claim 11, wherein the radiation sources for different types of radiation are arranged to emit their radiation onto parts of the curved mirror that have different curvatures.

13. The printer according to claim 11, further comprising a secondary mirror configured to deflect part of the radiation that has been deflected by the curved mirror, the secondary mirror deflecting the radiation onto a part of the print medium that is also eradiated by radiation that has been deflected only at the curved mirror.

14. The printer according to claim 1, wherein the curing unit is arranged to be moved relative to the print medium at constant speed.

15. The printer according to claim 10, further comprising:
a printhead that is arranged to move relative to the print medium in a main scanning direction; and
a support unit configured to move the print medium step-wise in a sub-scanning direction normal to the main scanning direction,
wherein the curing unit is configured to move in a reciprocating manner in a direction parallel to the sub-scanning direction.
